(19) United States
(12) Patent Application Publication
(10) Pub. No.: US 2022/0391401 A1
(43) Pub. Date: Dec. 8, 2022

(54) SYSTEM AND METHOD TO MODULATE METRIC VALUES OF THE RELIABILITY METRICS FOR THE INDIVIDUAL CONTRIBUTORS BASED UPON RECEIPT OF RELIABILITY FEEDBACK

(71) Applicant: Yehuda Gavrielov Regev, Los Altos, CA (US)

(72) Inventor: Yehuda Gavrielov Regev, Los Altos, CA (US)

(21) Appl. No.: 17/834,766

(22) Filed: Jun. 7, 2022

Related U.S. Application Data
(63) Continuation of application No. 63/208,427, filed on Jun. 8, 2021.

(51) Int. Cl. G06F 16/2457

(52) U.S. Cl. CPC G06F 16/24578

(57) ABSTRACT

Systems and methods to modulate metric values of the reliability metrics for the individual contributors based upon receipt of reliability feedback. A smart contract encodes automatic computer-executed rules for reliability metrics that indicate reliability of the individual contributors. Exemplary implementations executed by the smart contract: monitor receipt of specialized tokens at a topic address, on a decentralized ledger, associated with positive reliability feedback for a given contributor for a given topic, wherein the given contributor generates content items for the given topic and other topics that are presented via an online platform, wherein the online platform hosts the content items related to different topics for viewing and validating by users, wherein the users include the given contributor; and determine, based on the specialized tokens received at the topic address, a metric value of a given contributor-topic reliability metric for the given contributor for the given topic.

### FIELD OF THE DISCLOSURE

The present disclosure relates to system and method to modulate metric values of the reliability metrics for the individual contributors based upon receipt of reliability feedback.

### BACKGROUND

A multitude of resource websites exist such that an answer, provided by a contributor, to a question exists. However, search engines may not provide accurate answers or verify creditability of their contributors and/or may not websites that provide accurate answers and/or credible contributors in top results. Additionally, finding such answers and/or credible contributors may be difficult and time consuming for researchers, determining credibility and reliability of the answers and/or the contributors, and/or validating the answers found may be additionally time consuming for the researchers.

### SUMMARY OF THE INVENTION

One aspect of the disclosure relates to supporting contributors of content items. Specialized tokens can be used to endorse a contributor on a specific topic (e.g., health, gardening, etc.). The contributor may also be unendorsed. The contributor may receive any revenue from the specialized tokens used to endorse them. Further, if the contributor themselves validate a content item on a topic that they are heavily endorsed on, then their validation is more significant and contributes more to a reliability value for that content item. On the contrary, if the contributor validates or invalidates a content item on another topic that they are not endorsed much on, then their validation/invalidation does not affect the reliability value of that content item.

One aspect of the disclosure relates to implementing an endorsement protocol with a smart contract that manages community validation of contributors of content items. The system may include nodes or distributed computing platforms that include storage devices, physical processors, and/or other components. The physical processors may be configured by one or more smart contracts. The one or more smart contracts may be encoded automatic computer-executed rules for reliability metrics that indicate reliability of the individual contributors. The validation protocol may modulate metric values of the reliability metrics for the individual contributors based upon receipt of reliability feedback.

The one or more smart contracts may monitor receipt of specialized tokens at a topic address, on a decentralized database server, associated with positive reliability feedback for a given contributor and for a given topic. The given contributor may generate content items for the given topic and other topics that are presented via an online platform. The online platform may host the content items related to different topics for viewing and validating by users. The users may include the given contributor.

The one or more smart contracts may determine, based on the specialized tokens received at the topic address, a metric value of a given contributor-topic reliability metric for the given contributor for the given topic.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The drawings are provided for purposes of illustration only and merely depict typical or example implementations. These drawings are provided to facilitate the reader's understanding and shall not be considered limiting of the breadth, scope, or applicability of the disclosure. For clarity and ease of illustration, these drawings are not necessarily drawn to scale.

FIG. 1 illustrates a system for modulating metric values of the reliability metrics for the individual contributors based upon receipt of reliability feedback, in accordance with one or more implementations.

FIG. 2 illustrates an example implementation of the system for modulating metric values of the reliability metrics for the individual contributors based upon receipt of reliability feedback, in accordance with one or more implementations.

FIG. 3 illustrates a method for modulating metric values of the reliability metrics for the individual contributors based upon receipt of reliability feedback, in accordance with one or more implementations.

FIG. 4 illustrates a decentralized ledger that records information, in accordance with one or more implementations.

### DETAILED DESCRIPTION

The systems and methods described herein relate to facilitating endorsement of contributors of content items presented on an online platform. In various implementations, the systems and methods described herein may implement an endorsement protocol with built-in interventive response mechanisms to metric values of the reliability metrics for the individual contributors based upon receipt of reliability feedback. The endorsement protocol may be implemented with one or more smart contracts that manage community validation of the contributors of content items. The smart contract(s) may encode automatic computer-executed rules for the reliability metrics that indicate reliability of the individual contributors.

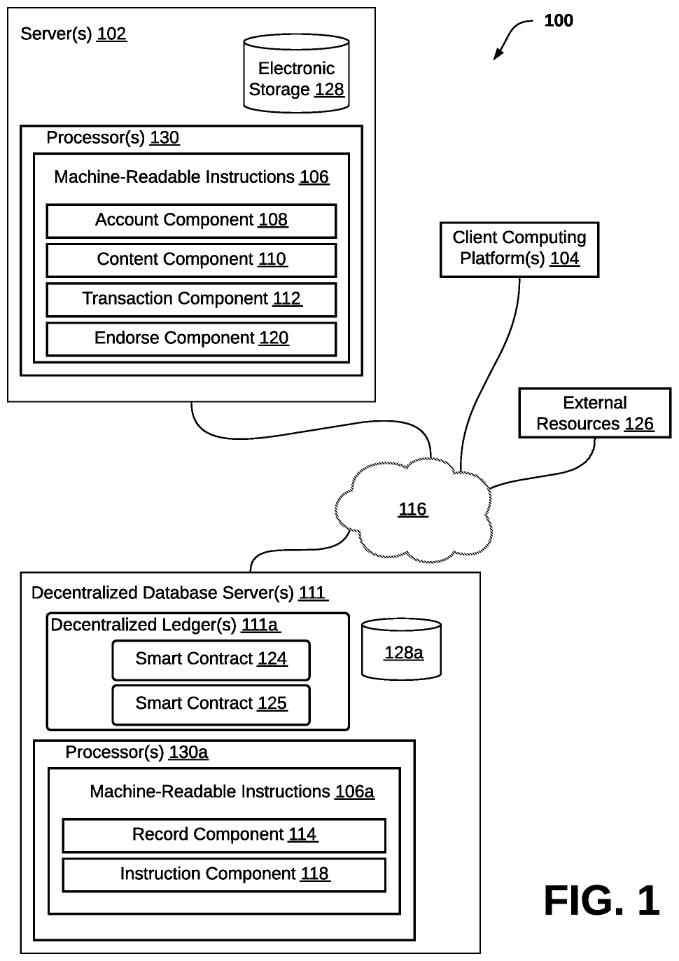

FIG. 1 illustrates a system 100 configured to facilitate endorsement of contributors of content items presented on an online platform, in accordance with one or more implementations. A content item, as used herein, may refer to user-generated informational content that informs users of the online platform about a topic and/or answers a specific question. The content items may be presented via the online platform that hosts the content items for viewing and validating by users. The users may include consumers of the online platform and the content items presented thereof and contributors that generate the content items. The content items may include one or more of a video, an audio bit, text, and/or other user-generated content related to the topic or the question. The online platform may refer to a platform accessible by users to determine reliability of informational content in the form of a content item, verify/validate the informational content included in the content items, invalidate the informational content included in the content items, consume the informational content, verify/validate the contributors of the content items on topics, invalidate the contributors of the content items on topics, and/or other actions. In some implementations, the online platform may be in the form of a website, a mobile application, a desktop application, and/or other form of distribution to the users. A given user validating the content item (and thus the informational content) may be that the given user agrees with the content item and deems the content item reliable for other users to accept. The given user invalidating the content item (and thus the informational content) may be that the given user disagrees with the content item and deems the content item unreliable for other users to accept. The given user validating the a given contributor may be that the given user agrees with the content item that the given contributor provided and deems the contributor reliable for other users to accept their answers on a particular topic of the content item. The given user invalidating the contributor may be that the given user disagrees with the contributor and deems the contributor unreliable for other users to accept their content items on the particular topic of the content item.

In some implementations, system 100 may include one or more servers 102, decentralized database server(s) 111, and/or other elements. The server(s) 102 may be configured to effectuate presentations of the content items provided by the contributors (e.g., by content component 110). Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104, e.g., through user interfaces. The users may be contributors that contribute the content items, consumers that consume the content items, and/or other types of users. In some implementations, an individual user may be both a contributor and a consumer.

Server(s) 102 may be configured by machine-readable instructions 106. Machine-readable instructions 106 may include one or more instruction components. The instruction components may include computer program components. The instruction components may include one or more of an account component 108, a content component 110, a transaction component 112, endorse component 120, and/or other components.

Account component 108 may be configured to maintain contributor accounts associated with the contributors. The contributor accounts may be defined by account information that includes a username, an amount of followers of the contributor accounts, an amount of contributor accounts being followed by the contributor account (and thus the contributor), one or more reliability metrics, an amount of specialized tokens available for purchase, a market price for an individual specialized token, accrued revenue (e.g., tokens, currency) from sales of the specialized tokens, a description, the content items generated by the contributor, the content items for sale, other specialized tokens (of other contributors) owned by the contributor, and/or other account information.

The one or more reliability metrics may include individual reliability metrics for the individual content items, an overall contributor reliability metric, a contributor-topic reliability metric, and/or other metrics. Metric values to the individual reliability metrics may indicate whether the corresponding content item is reliable or accurate to accept, or unreliable/inaccurate to accept. A metric value to the overall contributor reliability metric may indicate whether the corresponding contributor is reliable or unreliable to accept the content items they generate. Metric values to individual contributor-topic reliability metrics may indicate whether the contributor is reliable or unreliable to accept the content items on individual topics. Individual contributors may be associated with a fixed amount of specialized tokens that are exclusive to the individual contributor. For example, a first contributor may be associated with 100 first specialized tokens and a second contributor may be associated with 100 second specialized tokens (different from the first specialized tokens). The specialized tokens may only be usable to validate or invalidate the contributor, or content items generated thereof, that is associated with the specialized tokens. The market price of the individual specialized tokens may vary based on popularity of the contributor, the metric value to the one or more reliability metrics of the contributor, and/or other information. The accrued revenue may be in the form of a currency and/or particular tokens. For example, the accrued revenue may include one or more cryptocurrencies, platform tokens, non-fungible tokens, and/or other revenue forms for the accrued revenue from the sales of the specialized tokens.

The description may describe the contributor, the contributor account purpose, and/or other information. For example, the description may include an educational background of the contributor, one or more certifications of the contributor, professional experience of the contributor, and/or other information. In some implementations, the content items may be for sale or available for purchase by the users.

The users, such as the contributors, may purchase specialized tokens associated with other ones of the contributors. Ownership of the specialized tokens from the purchase may be indicated by the contributor accounts. The contributor accounts defined by the account information may be presented via the online platform for the users to view.

Content component 110 may be configured to obtain the content items associated with the contributors. The content items may be obtained via client computing platforms 104 associated with the contributors. In some implementations, the content items may be uploaded to the online platform. In some implementations, the content items may be generated within the online platform. For example, the contributor may be enabled by the online platform to record, input, and/or capture the individual content items. In some implementations, the content items may be associated with and/or identified by one or more keywords (e.g., hashtags) that facilitate searchability of the content items or searching for questions in which the content items inform about. A content item may be related to one or more of the topics. In some implementations, the one or more keywords may include the topics that the content items are related to. By way of non-limiting example, the topics may include health, beauty, law, hobbies (e.g., gardening, various sports, sewing, pottery), fitness, celebrity, cooking, decor, kids, animals, among others. Thus, a content item may be searchable by the one or more topics that it is related to. In some implementations, the contributor may associate the content item they generated with the one or more topics (e.g., via user input).

As such, the individual contributors accounts, and thus the account information, may further include particular ones of the topics that the contributors generated their content items for, and/or include provided positive or negative reliability feedback for other content items (presented via the online platform) related to the particular topics. That is, other content items of the particular topics that the contributor provided positive or negative reliability feedback for may be included in contributor accounts.

Content component 110 may be configured to effectuate presentation of the topics and the content items via the online platform to the users. In some implementations, the most popular or most searched topics over a period of time (e.g., in the last day, in the last week) may be presented first. Otherwise, the topics may be searched by their keywords via a user input by the users in a search bar or similar user interface element. In some implementations, the content items may be saved, shared, viewed multiple times, and/or other interactions by the users with the content items. The content items may be presented with corresponding user interface elements (e.g., virtual buttons) that represent validating and invalidating the content items. In some implementations, the particular topics associated with the individual contributors may be presented via an account page that corresponds to the contributor. In some implementations, the particular topics may be presented with corresponding user interface elements (e.g., virtual buttons) that represent validating and revoking validation the topics. The account page may present the account information in a readable format for the users.

Transaction component 112 may be configured to receive transaction information from client computing platforms 104 associated with the users. The transaction information may represent received revenue for the contributors in token-validation exchanges. The token-validation exchanges may be exchanges between the users and the contributors of an amount of currency exchanged for an amount of the specialized tokens associated with the individual contributors. That is, the users may purchase one or more of the specialized tokens from the contributor. An amount of platform tokens representative of the amount of currency may be transferred to contributor addresses associated with the individual contributors. The platform tokens may be particular to the online platform. Meaning, the contributor receives the platform tokens upon the user purchasing the specialized tokens rather than the contributor receiving the amount of currency directly. The amount of the platform tokens transferred to and received by the contributor may be based on the amount of the currency. Simultaneously, ownership rights to the specialized tokens and/or the platform tokens may be changed and/or recorded on decentralized ledger(s) accordingly as described herein. The contributors or users that hold the platform tokens may convert or exchange the platform tokens for other currencies or cryptocurrencies (e.g., US Dollars, BNB, etc.).

In some implementations, the topics may be associated with topic contributions. The topic contribution may be a required amount of currency, specialized tokens, and/or platform tokens for token endorsements to therefore provide the positive reliability feedback for the individual contributors on particular topics (i.e., receipt of the specialized tokens at the addresses associated with the positive reliability feedback for the individual topics associated with the contributors). A token endorsement may be provisions, by the users, to the contributors of the specialized tokens exclusive to the contributors at topic addresses on decentralized database server 111 associated with positive reliability feedback for the contributors on the different topics. The platform tokens representative of the amount of currency or the specialized tokens may be transferred to owner addresses associated with the contributors. The amount of currency, specialized tokens, and/or platform tokens being transferred may be based on the topic contribution.

In some implementations, endorse component 120 may be configured to receive contribution information related to the topic contributions. The contribution information may represent the topic contributions received by the contributors in the token endorsements.

In some implementations, specialized tokens, platform tokens, currency, rights (e.g., ownership rights) and/or other information may be recorded (and/or modified) on a decentralized ledger, including, e.g., decentralized ledger 111a. In some implementations, transaction component 112 may be configured to generate and transfer sets of instructions to decentralized database server 111 (in particular, to instruction component 118) to effectuate a transaction and/or modification on decentralized ledger 111a.

For example, the transactions and/or the rights pertaining to the token-validation exchanges may be recorded on decentralized ledger 111a. An exchange of an amount of currency from a user to a contributor for an amount of specialized tokens may be recorded on decentralized ledger 111a as a transaction between the user and the contributor. For example, exchanges of the specialized tokens from the user to addresses on decentralized database server 111 that are associated with positive reliability feedback and negative reliability feedback for a given content item (i.e., validate or invalidate the given content item) may be recorded on decentralized ledger 111a as a transaction between the user and the contributor that generated the given content item or the given content item itself. For example, in some implementations, the exchanges of the specialized tokens from the user to the addresses on decentralized database server 111 may be implemented as smart contracts that are recorded on decentralized ledger 111a.

The one or more decentralized database servers 111 may be configured to host, implement, and/or otherwise provide one or more decentralized ledger(s) 111a. In some implementations, decentralized database server(s) 111 may include one or more of electronic storage 128a, processor(s) 130a, machine-readable instructions 106a, and/or other components. Electronic storage 128a may be similar to electronic storage 128 as described elsewhere in this disclosure, though included in decentralized database server(s) 111. Processor(s) 130a may be similar to processor(s) 130 as described elsewhere in this disclosure, though included in decentralized database server(s) 111. Machine-readable instructions 106a may be similar to machine-readable instructions 106 as described elsewhere in this disclosure, though included in decentralized database server(s) 111. Decentralized ledger 111a may be used to record and/or otherwise store the account information for users of system 100, as well as other information related to the operation of system 100.

Decentralized database server(s) 111 may be used to implement one or more decentralized ledger(s) 111a. In some implementations, decentralized ledger 111a may be maintained by a distributed computing platform. The terms “client computing platform 104”, “distributed computing platform”, and variations thereof may be used interchangeably herein, and refer to the same element of system 100. In some implementations, the distributed computing platform may be implemented by a set of client computing platforms and/or servers (including, for example, one or more decentralized database server(s) 111). The distributed computing platform may support a virtual machine (not shown in FIG. 1). The distributed computing platform and/or the virtual machine may form a runtime environment for smart contracts and/or other executable code. In some implementations, the distributed computing platform may include electronic storage configured to store part or all, or a copy thereof, of decentralized ledger 111a. The smart contracts, such as smart contracts 124, may be stored on decentralized ledger 111a. In some implementations, the distributed computing platform may be the EOSIO platform. In some implementations, the distributed computing platform may be similar to or based on the EOSIO platform. In some implementations, the distributed computing platform may be Ethereum. In some implementations, the distributed computing platform may be similar to or based on Ethereum. In some implementations, the virtual machine may be a decentralized virtual machine.

In some implementations, at least one of the decentralized ledger(s) 111a implemented by decentralized database server(s) 111 is a private and/or permissioned decentralized ledger. The private permissioned decentralized ledger may be configured to record information and/or track addresses (e.g., corresponding to digital wallets, smart contracts, etc.). The recorded information may pertain to one or more assets (e.g., tokens) recorded on decentralized ledger(s) 111a. The recorded information may include ownership of the assets. For example, ownership rights and/or other rights may be modified. In some implementations, the ownership rights and/or other rights may be indicated by addresses tracked by decentralized ledger(s) 111a that correspond to digital wallets of users. In some implementations, for example, a non-fungible token may be removed from one decentralized ledger and added or recorded on another decentralized ledger. In some implementations, at least one of the decentralized ledger(s) 111a implemented by decentralized database server(s) 111 is a public decentralized ledger. The public decentralized ledger may be configured to be part of either EOSIO mainnet, Ethereum mainnet, Ethereum 1.5, Ethereum 2.0, a derivative of Ethereum 2.0 that is configured to perform transactions of Ether (ETH) between accounts, or a derivative of EOSIO that is configured to perform transactions of EOS between different accounts.

Elements of decentralized ledger(s) 111a ledger may be grouped together in units that are referred to as blocks. For example, an individual block may include one or more assets and/or one or more transactions. For example, an individual block may be linked to one or more other individual blocks. Individual blocks may be linked or chained together to form a structure of blocks and/or a hierarchy of blocks, such as, e.g., a chain of blocks. An individual block may include one or more assets, one or more transactions, and/or other information.

In some implementations, an individual decentralized database server(s) 111 may be dedicated to a particular node of a decentralized ledger(s) 111a. Typically, different nodes are included in (or implemented by, or hosted by) different servers or different computer systems to increase the safety and security of transactions on a decentralized ledger and/or blockchain. The consensus protocol used for a particular blockchain will be harder to falsify or circumvent when the different nodes are in different geographical locations, on different types of computing platforms, and/or otherwise distributed and diverse.

The set of client computing platforms and/or servers may include one or more processors configured by a smart contract 124 to monitor the receipt of specialized tokens at addresses on decentralized database server 111 that that separately are associated with positive reliability feedback and negative reliability feedback for the individual content items. The distributed computing platforms may automatically enforce smart contract 124, which may encode one or more computed-executed rules. These computed-executed rules may include data, machine-executable code, and/or other information that specifies actions that should be taken. When a system function is described herein, such as when smart contract 124 are described as performing a function, this function may be performed by the distributed computing platforms automatically by consulting the appropriate rule from smart contract 124 and thus smart contract 124 include computer-implemented functions. As such, the decision making of the cryptocurrency protocol may be made in a decentralized fashion, driven by automated execution of smart contract 124.

The monitoring may occur in an ongoing manner. The term “ongoing manner” as used herein may refer to continuing to perform an action (e.g., determine, monitor) periodically (e.g., every 30 seconds, every minute, every hour, etc.) or responsive to a trigger until receipt of an indication to terminate. The indication to terminate may include a function in smart contract 124, and/or other indications of termination. The trigger may include changes in ownership as indicated by the addresses, for example.

By way of non-limiting illustration, a first address and a second address associated with a given content item may be on decentralized database server 111. The first address may be associated with positive reliability feedback for the given content item. The second address may be associated with negative reliability feedback for the given content item. The one or more processors included in the set of client computing platforms and/or servers may be configured by smart contract 124 to monitor the receipt of the specialized tokens at the first address. The one or more processors included in the set of client computing platforms and/or servers may be configured by smart contract 124 to monitor the receipt of the specialized tokens at the second address on decentralized database server 111.

An amount of platform tokens may be determined automatically based on the specialized tokens deposited into the addresses associated with the positive reliability feedback (e.g., the first address) and distributed to individual owner addresses associated with owners of the corresponding content items. In some implementations, the owners of the content items may be the generator of the content items. In some implementations, the owners of the content items may be other users. The specialized tokens deposited into or sent to the addresses associated with the negative reliability feedback (e.g., the second address) are automatically distributed to a system address associated with the online platform that hosts the content items. In some implementations, the specialized tokens deposited to the second address may be redistributed back to the contributor account for future token-validation exchanges. In some implementations, the amount of the platform tokens (that represent the amount of currency) transferred to the contributor address may be revoked, or transferred from the contributor address to the system address. Thus, the contributor of the given content item does not receive benefits (i.e., the platform tokens) for unvalidated or inaccurate content items. In some implementations, the content items may be associated with a contribution. The contribution may be a required amount of currency or platform tokens for the token-validation exchange to therefore provide the positive or negative reliability feedback for the content items (i.e., receipt of the specialized tokens at the respective addresses associated with the positive or negative reliability feedback for the individual content items). The amount of platform tokens being transferred, and the amount of currency being exchanged may be based on the contribution.

The one or more processors included in the set of client computing platforms and/or servers may be configured by smart contract 124 to determine the metric values of the reliability metrics for the individual content items based on the specialized tokens received at the addresses associated with the positive reliability feedback and the negative reliability feedback for the content items. By way of non-limiting illustration, a metric value of a reliability metric for the given content item may be determined based on the specialized tokens received at the first address and the second address. The metrics values to the reliability metrics may indicate whether the corresponding content item is reliable or accurate to accept, or unreliable/inaccurate to accept. In some implementations, the metric values to the reliability metrics may be a number, a percentage, a letter score, and/or other metric value. For example, a high number metric value may indicate that the content item is reliable and accurate, and a low number metric value may indicate the content item is unreliable and inaccurate. The metric values to the reliability metrics may be transferred to server(s) 102 and/or other servers. In some implementations, the metric values to the reliability metrics may be transferred in an ongoing manner.

Content component 110 may be configured to receive the metric values to the reliability metrics for the content items. Content component 110 may be configured to effectuate presentation of the metric values to the reliability metrics in relation to the respective content items via the online platform. The receipt of the metric values and presentation thereof may occur upon determination of the metric values and/or changes thereof.

The one or more processors of the set of client computing platforms and/or servers may further be configured by a smart contract 125 to monitor the receipt of specialized tokens at a topic address on decentralized database server 111 associated with positive reliability feedback for individual contributors for individual topics the individual contributors have generated content items for. By way of non-limiting illustration, receipt of the specialized tokens at a given topic address associated with positive reliability feedback a given contributor and for a given topic (e.g., health) may be monitored.

The one or more processors of the set of client computing platforms and/or servers may further be configured by smart contract 125 to determine metrics values of contributor-topic reliability metrics for the individual contributors on the individual topics. The metric values of contributor-topic reliability metrics may be based on the specialized tokens received at the corresponding topic address. The metric values to the contributor-topic reliability metrics may indicate whether the contributor is reliable on a particular topic. By way of non-limiting illustration, a metric value of a given contributor-topic reliability metric for the given contributor for the given topic may be determined based on the specialized tokens received at the first topic address. In some implementations, for example, a higher percentage (e.g., 93%) as the metric value for the given topic related to the given contributor may indicate that the given contributor is reliable on the given topic as opposed to a low percentage (e.g., 22%). The specialized tokens deposited into the topic address may automatically be distributed to the owner address associated with the contributor. Thus, the contributors may benefit from the positive reliability feedback on the particular topics.

In some implementations, the one or more processors of the set of client computing platforms and/or servers may further be configured by smart contract 125 to monitor withdrawals of the specialized tokens at the topic addresses. The withdrawal may refer to sending a withdrawal specialized token to the topic addresses. Such receipt of the withdrawal specialized token may represent a withdrawal of validation or endorse of the respective contributor and the topic and/or lack of endorsement of the respective contributor and the topic. The withdrawals may affect the metric values of the contributor-topic reliability metrics. That is, the receipt of the withdrawal specialized tokens at the given topic address may represent retracting positive reliability feedback for the given contributor on the given topic (i.e., a user does not deem the given contributor reliable anymore). As such, the metric value for the given contributor-topic reliability metric may be decreased or otherwise indicate less reliability at determination.

In some implementations, the one or more processors of the set of client computing platforms and/or servers may further be configured by smart contract 125 to monitor the receipt of other specialized tokens (exclusive to other contributors) from owner addresses at addresses on decentralized database server 111 that associated with positive reliability feedback and negative reliability feedback (e.g., the first address and the second address, respectively) for other content items generated by the other contributors. By way of non-limiting illustration, receipt of second specialized tokens exclusive to a second contributor, from the owner address associated with the given contributor, at primary address (associated with positive reliability feedback) and secondary address (associated with negative reliability feedback) for a first content item generated by the second contributor may be monitored and determined. The first content item may be of or related to the given topic. the metric value of the given contributor-topic reliability metric may indicate reliability of the given contributor on the given topic.

In some implementations, the one or more processors of the set of client computing platforms and/or servers may further be configured by smart contract 125 to monitor the receipt of the second specialized tokens, from the owner address associated with the given contributor, at a third address and fourth address on decentralized database server 111 associated with positive reliability feedback and negative reliability feedback, respectively, for a second content item generated by the second contributor. The second content item may be of or related to a second topic that is not the given topic or other topics with metric values of contributor-topic reliability metrics that indicate reliability of the given contributor on the other topics.

In some implementations, the one or more processors of the set of client computing platforms and/or servers may further be configured by smart contract 125 to determine metric values of the reliability metrics for the content items, such as the first content item and the second content item, based on the metric values to the contributor-topic reliability metrics that the content items are related to and that the given contributor provided positive or negative reliability feedback for (by way of the specialized tokens). By way of non-limiting illustration, a first metric value of a first reliability metric for the first content item may indicate that the first content item is reliable upon the metric value to the contributor-topic reliability metric, herein after primary metric value, indicating that the contributor is reliable for the given topic. The affect of the primary metric value on the first metric value may be significant where the first metric value indicates meaningful reliability upon the primary metric value (associated with the given contributor and the given topic) indicating that the given contributor is reliable on the given topic. Meaning, upon the given contributor being reliable on the given topic and subsequently the given contributor provides positive reliability feedback/validates or provides negative reliability feedback/invalidates the first content item that is related to the given topic, the reliability of the first content item (i.e., the first metric) may be changed significantly than before the validation or invalidation from the given contributor. For example, upon the given contributor providing negative reliability feedback on the first content item, the reliability (i.e., the first metric) may be lowered and thus indicate less reliability.

As another example, a second metric value of a second reliability metric for the second content item may be unaffected upon the metric values to the contributor-topic reliability metrics indicating that the contributor is unreliable for the second topic. That is, upon the given contributor providing positive or negative reliability feedback (i.e., validates or invalidates) the second content item that is related to the second topic that the given contributor is not indicated as reliable on, the reliability of the second content item (i.e., the second metric) may not be affected or change.

Decentralized ledger 111a may be a decentralized ledger that records rights pertaining to digital assets. As used herein, the term “digital asset” may refer to a serial code tracked on one or more decentralized ledgers. The digital assets may be uniquely identified and/or uniquely identifiable. As used herein, rights pertaining to digital assets may be tracked, recorded, and/or otherwise registered on one or more decentralized ledgers. As such, an individual digital asset may be a ledger-tracked digital asset.

Individual digital assets may be associated and/or correlated with another entity (which may be referred to as a “correlated entity”) by virtue of technology provided and/or supported by the one or more decentralized ledgers on which the rights pertaining to the individual digital assets is tracked (including but not limited to smart contracts and/or other executable code on the one or more decentralized ledgers). Accordingly, rights pertaining to a digital asset may correlate to the provision of one or more rights (e.g., accessibility) with respect to the correlated entity (e.g., control and/or other accessibility). Transactions involving a digital asset recorded on a decentralized ledger may correlate to certain transactions (or modifications) of the correlated entity, and/or vice versa. For example, the correlated entities may include the content items and/or other entities.

Various types and/or combinations of correlated entities are envisioned within the scope of this disclosure, including but not limited to physical and/or virtual objects. The use of the singular “entity” or “correlated entity” is not intended to be limiting, as multiple different objects, content, items, rights, memberships, grants, etc. may be correlated to a single digital asset. By way of non-limiting example, a correlated entity may be a physical item (e.g., artwork, a ticket to an event), a subscription to certain media content, the content items, and so forth. The content items may include an image, a video, a graphic image file, a signature of notoriety, a sound bite of an audio file, the audio file, text, and/or other content. In some implementations, the correlated entity may refer to any item or object related to education and/or other industries for which a user may use, own, sell, trade, loan, destroy, and/or otherwise effectuate a change of ownership, access, or control.

A digital asset may be fungible if it is functionally and/or physically indistinguishable from another digital asset. A digital asset may be non-fungible if it is unique, or one-of-a-kind. For example, a specific individual may be non-fungible. A digital asset may be semi-fungible if there is a set of a limited number of similar but distinguishable digital assets. For example, a limited amount of images of sports team for a particular year may be semi-fungible. For example, a digital ticket to a show, concert, exhibition, and/or other event may be semi-fungible. The semi-fungible digital assets are considered as unique, “not fungible”, or non-fungible digital assets. In some implementations, the digital assets may include non-fungible tokens, fungible tokens, semi-fungible tokens, security tokens, utility tokens, payment tokens, initial coin offering (ICO) tokens, virtual currency tokens, crypto tokens, ERC-20 tokens, EOS tokens, specialized tokens, platform tokens, and/or other digital assets or tokens. In some implementations, digital assets not only represent value, but may have a specific use in a particular distributed computing platform, e.g., in the operation of decentralized ledger 111a.

For example, a blockchain is a type of ledger, as well as a type of decentralized database that records rights pertaining to digital assets. A given (digital) asset may be owned by a particular user. An asset may include anything of material value or usefulness that is owned by or on behalf of one or more users. A correlated entity (e.g., the content items) may be represented by a digital asset that is recorded on decentralized ledger 111a. In some implementations, a right pertaining to an object (e.g., a distribution right) may be an asset, the object being a physical or a virtual item. Multiple rights may form a set of rights or a bundle of rights that may be transferred and/or otherwise acted on and/or operated on together. For example, rights may include one or more of a right to use, a right to sell, a right to destroy, a right to certain types of distributions, and/or other rights. For example, in some implementations, rights pertaining to a virtual item (e.g., ownership) may be recorded on decentralized ledger 111a.

In some implementations, decentralized ledger 111a may register transactions that modify ownership (and/or other rights) pertaining to digital assets. A smart contract may implement a (type of) digital asset. For example, smart contract 124 may implement at least a part of an exchange between addresses that indicate positive or negative reliability feedback. In some implementations, once a smart contract has been added to a blockchain, the smart contract may be referred to as published, posted, registered, and/or recorded. Elements of decentralized ledger 111a may be grouped together in units that are referred to as blocks. For example, an individual block may include one or more assets and one or more transactions. For example, an individual block may be linked to one or more other individual blocks. Individual blocks may be linked or chained together to form a structure of blocks and/or a hierarchy of blocks, such as, e.g., a chain of blocks. An individual block may include one or more assets, one or more transactions, and/or other information. By way of non-limiting example, digital assets may represent virtual items. In some implementations, virtual items may include one or more of (content) reliability metrics, (contributor) reliability metrics, accomplishments, (user-specific) awards, access rights within an online game, and/or other virtual items. In some implementations, virtual items may refer to any item or object within a gaming platform that a user may use, own, sell, trade, destroy, and/or otherwise effectuate a change of ownership of.

In some implementations, decentralized ledger 111a may be publicly accessible and append-only. In some implementations, existing blocks of decentralized ledger 111a can substantially not be altered or deleted, unless multiple copies are altered. This is unlikely to happen provided that multiple copies of decentralized ledger 111a are stored on different computing platforms, e.g., in different geographical locations. Decentralized ledger 111a may be replicated on multiple computing platforms, preferably in multiple different geographical locations. Additionally, individual blocks may be linked together in a manner that prevents tampering, such as, e.g., using a hash chain and/or digital signatures. In particular, hash values may be generated using fixed-output-length one-way hashing functions that take variable-length input, and may be effectively impossible (or, at least, computationally infeasible) to reverse. As such, a hashing function may provide one-way encryption. By way of non-limiting example, the hashing function may be SHA-256, BLAKE2, SHAKE256, and/or another hashing function. Contents of individual blocks, transactions, and/or assets may be digitally signed in a manner that proves integrity and/or prevents tampering, e.g., by providing authentication.

In some implementations, decentralized database server(s) 111 may include record component 114, instruction component 118, and/or other components. Instruction component 118 may be configured to receive (sets of) instructions to add, modify, and/or remove recorded rights in decentralized ledger 111a. Instruction component 118 may be configured to receive (sets of) instructions to add transactions of tokens and/or other digital assets to decentralized ledger 111a. Instruction component 118 may provide received sets of instructions to record component 114 for execution. In some implementations, instruction component 118 may be arranged, organized, and/or otherwise included in decentralized database server 111.

Record component 114 may be configured to record rights pertaining to digital assets and/or transactions of tokens and/or other digital assets on decentralized database server(s) 111 and/or decentralized ledger 111a. In some implementations, record component 118 may record rights on decentralized ledger 111a. In some implementations, record component 114 may add, modify, and/or remove recorded rights. For example, in accordance with received instructions, record component 114 may transfer ownership of a particular digital asset from a first owner/user to a second owner/user (e.g., from an original owner to a new owner). In some implementations, record component 114 may be arranged, organized, and/or otherwise included in decentralized database server 111.

The recorded rights may include ownership rights, distribution rights, and/or other rights. For example, particular recorded rights may reflect ownership of a particular digital asset by a particular user. Recorded rights may be asset-specific. For example, distribution rights for a particular content item may designate rights to certain distributions of benefits upon an exchange involving the particular content item. For example, the asset-specific distribution rights for a particular content item may include one or more of (i) a right owned by a different user to a part of the benefits upon an exchange, (ii) a right owned by one or more stakeholders of system 100 to a part of the benefits upon an exchange, and/or other distribution rights. These parts of a benefit may have different sizes, percentages, and/or conditions.

In some implementations, the contributor accounts and the account information thereof may be stored or recorded, at least in part, on decentralized ledger 111a, electronic storage 128, and/or electronic storage 128a. For example, individual contributor accounts may include information that links to and/or otherwise refers to decentralized ledger 111a. For example, a balance of credits, points, tokens, currencies, metrics, and/or other information may be recorded on decentralized ledger 111a.

In some implementations, by way of non-limiting example, instruction component 118 may be configured to receive a first set of instructions to record, on decentralized ledger 111a, the transaction information pertaining to individual ones of the token-validation exchanges. The recorded transaction information may reflect the amount of the platform tokens received by the contributor address and ownership rights to the specialized tokens. Record component 114 may be configured to execute the first set of instructions. In some implementations, by way of non-limiting example, instruction component 118 may be configured to receive a second set of instructions to record, on decentralized ledger 111a, smart contract 124. Record component 114 may be configured to execute the second set of instructions.

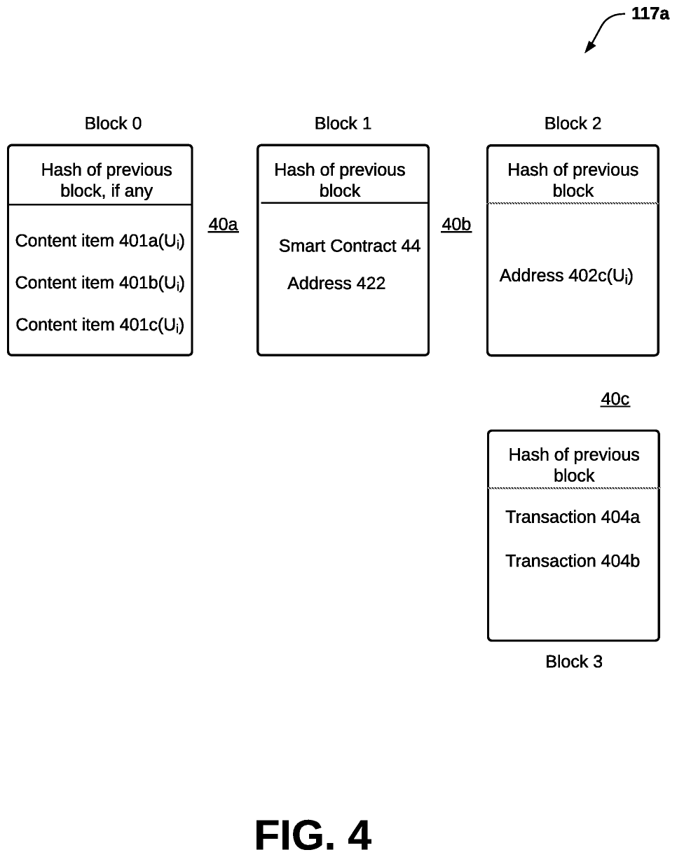

FIG. 4 illustrates a blockchain 117a that includes a block 0, a block 1, a block 2, and block 3. As time progresses, more blocks may be added to blockchain 117a. The blocks within blockchain 117a are ordered. In block 0, three assets, content items 401a-c are generated by and/or owned by user i (Uᵢ). Content items 401a-c may be of a first topic.

For example, the assets in block 0 may be individual content items generated and posted via an online platform, such as the online platform described in FIG. 1, and correlated to individual digital assets. Block 1 is connected to block 0 (as indicated by a link 40a), for example by including an address of block 1 in block 0, or vice versa. Likewise, block 1 is connected to block 2, as indicated by a link 40b, and block 3 may be connected to block 2 as indicated by a link 40c.

In block 1, a smart contract 44 is posted. For example, smart contract 44 may have been received by a component similar to instructions component 118 or generated or obtained, and may have been posted to blockchain 117a by a component similar to record component 114 (shown in FIG. 1). Smart contract 44 may specify topic address 422 associated with positive reliability feedback for user i (i.e., a contributor) and the first topic. Topic address 422 may be monitored for receipt of specialized tokens, withdrawal specialized tokens, and/or other currencies. In some implementations, a smart contract may be appended to a distributed blockchain as soon as a contributor, as described in FIG. 1, creates a contributor account and/or creates their first content item.

Additionally, block 2 may include address 402c associated with user i. That is, address 402c may indicate ownership of digital assets, currencies, and/or other ownerships.

Block 3 includes transaction 404a-c. For example, transaction 404a may represent a purchase of specialized tokens by user i and thus the specialized tokens may be transferred to address 402c associated with user i, transaction 404b may represent a transfer of the specialized tokens to topic address 4222 and thus providing positive reliability feedback for user i and for the first topic.

In some implementations, based on the contents of the blocks, any user of blockchain 117a may determine the current assets of blockchain 117a. For example, an individual user may not be allowed to transfer more assets than the individual user owns.

Referring back to FIG. 1, in some implementations, by way of non-limiting example, instruction component 118 may be configured to receive (a third) set of instructions to record, on decentralized ledger 111a, smart contract 125. Record component 114 may be configured to execute the third set of instructions. In some implementations, by way of non-limiting example, instruction component 118 may be configured to receive a (fourth) set of instructions to record, on decentralized ledger 111a, the contribution information pertaining to individual ones of the token endorsements. The recorded contribution information may reflect the amount of the platform tokens received by the topic addresses. Record component 114 may be configured to execute the fourth set of instructions.

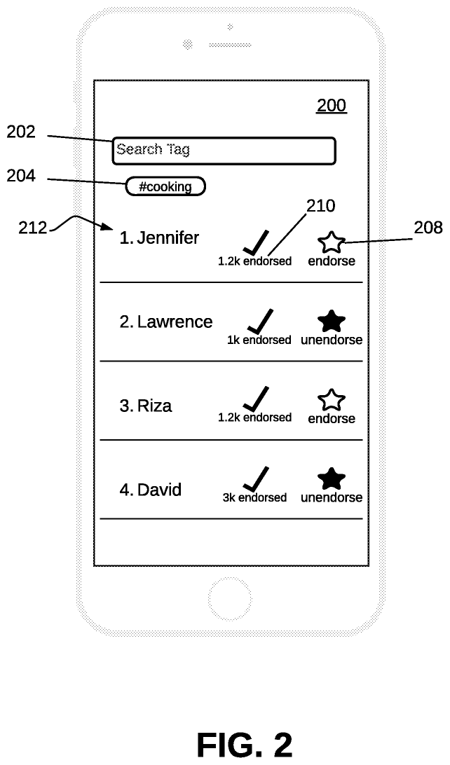

FIG. 2 illustrates a view of an online platform 200 that host content items and contributors for validation feedback. Online platform 200 may include search bar 202 where a user may search for a topic 204 (e.g., cooking). Contributor set 212 including contributors (e.g., Jennifer, Lawrence, Riza, and David) that have content items on topic 204 and/or are indicated as reliable on topic 204 (according to contributor-topic reliability metric values) may be presented. The user may provide positive reliability feedback (or endorse) for each of the contributors on topic 204 by selecting button 208. Conversely, button 208 may be selected to revoke the positive reliability feedback (or unendorse) the contributors (by way of transferring withdrawal specialized tokens to a topic address associated with cooking and Jennifer, for example). Each of the contributors of the contributor set 212 may include a total endorsement 210 that indicate how many users have validated/endorsed that the contributor is reliable on topic 204.

Referring back to FIG. 1, in some implementations, server(s) 102, client computing platform(s) 104, and/or external resources 126 may be operatively linked via one or more electronic communication links. For example, such electronic communication links may be established, at least in part, via one or more networks 16 such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more (hardware) processors 130, and/or other components. Server(s) 102 may include communication lines, or ports to enable the exchange of information with network 16 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102. In some implementations, servers 102 may include one or more content servers.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 118, and/or 120, and/or other components. Processor(s) 130 may be configured to execute components 108, 110, 112, 114, 118, and/or 120, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

It should be appreciated that although components 108, 110, 112, 114, 118, and/or 120 are illustrated in FIG. 1 as being implemented within a single processing unit, in implementations in which processor(s) 130 includes multiple processing units, one or more of components 108, 110, 112, 114, 118, and/or 120 may be implemented remotely from the other components. The description of the functionality provided by the different components 108, 110, 112, 114, 118, and/or 120 described below is for illustrative purposes, and is not intended to be limiting, as any of components 108, 110, 112, 114, 118, and/or 120 may provide more or less functionality than is described. For example, one or more of components 108, 110, 112, 114, 118, and/or 120 may be eliminated, and some or all of its functionality may be provided by other ones of components 108, 110, 112, 114, 118, and/or 120. As another example, processor(s) 130 may be configured to execute one or more additional components that may perform some or all of the functionality attributed below to one of components 108, 110, 112, 114, 118, and/or 120.

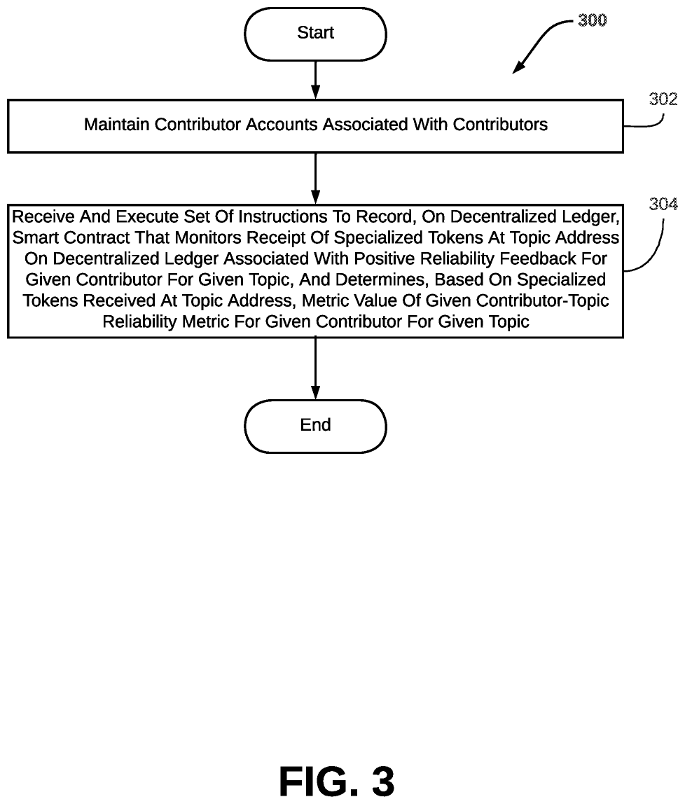

FIG. 3 illustrates an example of a process 300 of modulating metric values of reliability metrics for individual contributors based upon receipt of reliability feedback, according to an implementation of the invention. In various implementations, process 300 may be implemented via one or more smart contracts. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations may occur substantially simultaneously. The described operations may be accomplished using some or all of the system components described in detail above.

In some implementations, process 300 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of process 300 in response to instructions stored electronically on one or more electronic storage mediums. The one or more processing devices may include one or more devices configured through hardware, firmware, and/or software to be specifically designed for execution of one or more of the operations of process 300.

Operation 302 may include maintaining contributor accounts associated with the contributors. Operation 302 may be performed by one or more hardware processors configured by machine-readable instructions including a component that is the same as or similar to account component 108, in accordance with one or more implementations.

Operation 304 may include receiving and executing a set of instructions to record, on the decentralized ledger, a smart contract. The smart contract may include monitoring the receipt of specialized tokens at a topic address on the decentralized database server associated with positive reliability feedback for a given contributor for a given topic, wherein the given contributor generates content items for the given topic and other topics that are presented via the online platform, wherein the online platform hosts the content items related to different topics for viewing and validating by the users, wherein the users include the given contributor, and (ii) determining, based on the specialized tokens received at the topic address, a metric value of a given contributor-topic reliability metric for the given contributor for the given topic. Operation 312 may be performed by one or more hardware processors configured by machine-readable instructions including a component that is the same as or similar to instruction component 118 and record component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to facilitate endorsement of contributors of content items presented on an online platform, the system comprising:
a server configured to effectuate presentations of content items related to topics provided by contributors and contributor accounts for the contributors, wherein the server includes one or more hardware processors configured by machine-readable instructions to:
maintain the contributor accounts associated with the contributors, wherein the contributor accounts include particular topics that the contributors generated the content items for, and/or provided positive or negative reliability feedback for other content items related to the particular topics presented via an online platform; and
effectuate presentations of the particular topics via the online platform to users; and
a decentralized database server configured to implement a decentralized ledger, wherein the decentralized database server comprises one or more processors configured by machine-readable instructions to:
receive and execute a set of instructions to record, on the decentralized ledger, a smart contract configured to: (i) monitor receipt of specialized tokens at a topic address on the decentralized ledger associated with positive reliability feedback for a given contributor for a given topic, wherein the given contributor generates content items for the given topic and other topics that are presented via the online platform, wherein the online platform hosts the content items related to different topics for viewing and validating by the users, wherein the users include the given contributor, (ii) determine, based on the specialized tokens received at the topic address, a metric value of a given contributor-topic reliability metric for the given contributor for the given topic.

2. The system of claim 1, wherein the content items include one or more of a video, an audio bit, or text related to a topic or question.

3. The system of claim 1, wherein the topics are associated with topic contributions.

4. The system of claim 3, wherein:
the one or more processors of the server are further configured by the machine-readable instructions to:
receive contribution information related to the topic contributions, wherein the contribution information represents the topic contributions received by the contributors in token endorsements, wherein the token endorsements are provisions by the users to the contributors of the specialized tokens exclusive to the contributors at topic addresses as the positive reliability feedback for the contributors on the different topics, wherein an amount of platform tokens representative of an amount of currency exchanged for the provisions is transferred to the topic addresses;
the one or more processors of the decentralized database server are further configured by the machine-readable instructions to:
receive and execute a secondary set of instructions to record, on the blockchain, the contribution information pertaining to individual ones of the token endorsements, wherein the recorded contribution information reflects the amount of the platform tokens received by the topic addresses.

5. A system configured to implement an endorsement protocol with a smart contract that manages community validation of contributors of content items, the smart contract encoding automatic computer-executed rules for reliability metrics that indicate reliability of the individual contributors, the validation protocol modulating metric values of the reliability metrics for the individual contributors based upon receipt of reliability feedback, the system comprising:
one or more physical processors configured by the smart contract to:
monitor receipt of specialized tokens at a topic address, on a decentralized database server, associated with positive reliability feedback for a given contributor and for a given topic, wherein the given contributor generates content items for the given topic and other topics that are presented via an online platform, wherein the online platform hosts the content items related to different topics for viewing and validating by users, wherein the users include the given contributor; and
determine, based on the specialized tokens received at the topic address, a metric value of a given contributor-topic reliability metric for the given contributor for the given topic.

6. The system of claim 5, wherein the specialized tokens deposited into the topic address are automatically distributed to an owner address associated with the given contributor.

7. The system of claim 5, wherein the one or more physical processors are further configured by the smart contract to:
monitor receipt of withdrawal specialized tokens at the topic address associated with the given topic, wherein the receipt of the withdrawal specialized tokens affects the metric value of the given contributor-topic reliability metric.

8. The system of claim 5, wherein the specialized tokens are exclusive to the individual contributors, wherein the one or more physical processors are further configured by the smart contract to:
monitor receipt of second specialized tokens exclusive to a second contributor, from an owner address associated with the given contributor, at addresses, on the decentralized ledger, associated with positive reliability feedback and negative reliability feedback for a first content item generated by the second contributor, wherein the first content item is of the given topic, wherein the metric value of the given contributor-topic reliability metric indicates reliability;
monitor the receipt of the second specialized tokens, from the owner address, at addresses on the decentralized database server associated with positive reliability feedback and negative reliability feedback for a second content item generated by the second contributor, wherein the second content item is of a second topic, wherein the second topic is not the given topic or the other topics with metric values of contributor-topic reliability metrics that indicate reliability; and
determine, based on the metric values to the contributor-topic reliability metrics, metric values of reliability metrics for the content items including the first content item and the second content item such that a first metric value of a first reliability metric for the first content item indicates that the first content item is reliable upon the metric value to the contributor-topic reliability metric indicating that the contributor is reliable for the given topic, and a second metric value of a second reliability metric for the second content item is unaffected upon the metric values to the contributor-topic reliability metrics indicating that the contributor is unreliable for the second topic.

9. A method to facilitate endorsement of contributors of content items presented on an online platform, the method comprising:
effectuating presentations of content items related to topics provided by contributors and contributor accounts for the contributors;
maintaining the contributor accounts associated with the contributors, wherein the contributor accounts include particular topics that the contributors generated the content items for, and/or provided positive or negative reliability feedback for other content items related to the particular topics presented via an online platform;
effectuating presentations of the particular topics via the online platform to users; and
receiving and executing a set of instructions to record, on a decentralized ledger implemented by a decentralized database server, a smart contract configured to: (i) monitor receipt of specialized tokens at a topic address on the decentralized ledger associated with positive reliability feedback for a given contributor for a given topic, wherein the given contributor generates content items for the given topic and other topics that are presented via the online platform, wherein the online platform hosts the content items related to different topics for viewing and validating by the users, wherein the users include the given contributor, (ii) determine, based on the specialized tokens received at the topic address, a metric value of a given contributor-topic reliability metric for the given contributor for the given topic.

10. The method of claim 9, wherein the content items include one or more of a video, an audio bit, or text related to a topic or question.

11. The method of claim 9, wherein the topics are associated with topic contributions.

12. The method of claim 11, further comprising:
receiving contribution information related to the topic contributions, wherein the contribution information represents the topic contributions received by the contributors in token endorsements, wherein the token endorsements are provisions by the users to the contributors of the specialized tokens exclusive to the contributors at topic addresses as the positive reliability feedback for the contributors on the different topics, wherein an amount of platform tokens representative of an amount of currency
receiving and executing a secondary set of instructions to record, on the blockchain, the contribution information pertaining to individual ones of the token endorsements, wherein the recorded contribution information reflects the amount of the platform tokens received by the topic addresses.

13. A method configured to implement an endorsement protocol with a smart contract that manages community validation of contributors of content items, the smart contract encoding automatic computer-executed rules for reliability metrics that indicate reliability of the individual contributors, the validation protocol modulating metric values of the reliability metrics for the individual contributors based upon receipt of reliability feedback, the method comprising:
monitoring, by the smart contract, receipt of specialized tokens at a topic address, on a decentralized ledger, associated with positive reliability feedback for a given contributor for a given topic, wherein the given contributor generates content items for the given topic and other topics that are presented via an online platform, wherein the online platform hosts the content items related to different topics for viewing and validating by users, wherein the users include the given contributor; and
determining, based on the specialized tokens received at the topic address, a metric value of a given contributor-topic reliability metric for the given contributor for the given topic.

14. The method of claim 13, wherein the specialized tokens deposited into the topic address are automatically distributed to an owner address associated with the given contributor.

15. The method of claim 13, further comprising:
monitoring, by the smart contract, receipt of withdrawal of specialized tokens at the topic address associated with the given topic, wherein the receipt of the withdrawal specialized tokens affects the metric value of the given contributor-topic reliability metric.

16. The method of claim 13, wherein the specialized tokens are exclusive to the individual contributors, further comprising:
monitoring, by the smart contract, receipt of second specialized tokens exclusive to a second contributor, from an owner address associated with the given contributor, at addresses, on the decentralized ledger, associated with positive reliability feedback and negative reliability feedback for a first content item generated by the second contributor, wherein the first content item is of the given topic, wherein the metric value of the given contributor-topic reliability metric indicates reliability;
monitoring, by the smart contract, the receipt of the second specialized tokens, from the owner address, at addresses on the decentralized database server associated with positive reliability feedback and negative reliability feedback for a second content item generated by the second contributor, wherein the second content item is of a second topic, wherein the second topic is not the given topic or the other topics with metric values of contributor-topic reliability metrics that indicate reliability; and
determining, by the smart contract, based on the metric values to the contributor-topic reliability metrics, metric values of reliability metrics for the content items including the first content item and the second content item such that a first metric value of a first reliability metric for the first content item indicates that the first content item is reliable upon the metric value to the contributor-topic reliability metric indicating that the contributor is reliable for the given topic, and a second metric value of a second reliability metric for the second content item is unaffected upon the metric values to the contributor-topic reliability metrics indicating that the contributor is unreliable for the second topic.
